(19) United States
(12) Patent Application Publication
(10) Pub. No.: US 2023/0030049 A1
(43) Pub. Date: Feb. 2, 2023

(54) DEVICE AND METHOD FOR GENERATING GRAPHICAL USER INTERFACE TEST CASE

(71) Applicants: HYUNDAI MOTOR COMPANY, Seoul (KR); Kia Corporation, Seoul (KR)

(72) Inventors: Seok Ki HONG, Suwon-si (KR); Hyung Seok LEE, Seoul (KR); Seung Yeun JANG, Seoul (KR)

(73) Assignees: HYUNDAI MOTOR COMPANY, Seoul (KR); Kia Corporation, Seoul (KR)

(21) Appl. No.: 17/667,785

(22) Filed: Feb. 9, 2022

(30) Foreign Application Priority Data
Jul. 27, 2021 (KR) 10-2021-0098636

(51) Int. Cl. G06F 11/36

(52) U.S. Cl. CPC G06F 11/3684; G06F 11/3688; G06F 11/3696

(57) ABSTRACT

A graphical user interface (GUI) test case generating device may include a communication device that communicates with a GUI system mounted on a vehicle, and a controller that collects screen information and event information according to a user’s manipulation through the communication device, and generates a GUI test case based on the collected screen information and event information.

### CROSS-REFERENCE TO RELATED APPLICATION

This application claims the benefit of priority to Korean Patent Application No. 10-2021-0098636, filed in the Korean Intellectual Property Office on Jul. 27, 2021, the entire contents of which are incorporated herein by reference.

### TECHNICAL FIELD

The present disclosure relates to a technology for generating a GUI (Graphical User Interface) test case based on big data.

### BACKGROUND

In general, graphical user interfaces (GUIs) visually express information to increase manipulation and accessibility for information, become an important means for interaction between users and systems, and allow users to easily operate software.

Therefore, the GUI applied to a system or device and displayed on the screen needs to be tested to verify the safety, robustness, and usability of the system.

However, tests for the GUI include both an independent operation test of the GUI and an operation test inside the software according to the operation of the GUI, thereby requiring more complex and larger amount of test work than a normal software test process. In addition, various GUI combinations may be generated regardless of test codes, resulting in a wide range of tests to be performed. In addition, as menu structures for user-oriented service support become complicated, the time required for testing increases.

Due to this, developers need to put a lot of effort to perform tests on the GUI. In other words, it takes a lot of time and effort for the developers to manually create, maintain, and evaluate test cases required for GUI testing. In particular, the developers need to create various and useful test cases to faithfully test the GUI.

A conventional GUI test automation system tests the GUI based on the test cases created manually by the developers, but there is a problem in that a faithful GUI test cannot be made because these test cases are limited and the usage frequency among users is not high.

The matters described in this background are prepared to enhance an understanding of the background of the present disclosure, and may include matters other than the prior art already known to those of ordinary skill in the field to which this technology belongs.

### SUMMARY

The present disclosure has been made to solve the above-mentioned problems occurring in the prior art while advantages achieved by the prior art are maintained intact.

An aspect of the present disclosure provides a graphical user interface (GUI) test case generating device which collects screen information and event information according to the manipulation of a user from a GUI system mounted on each vehicle and generates a test case based on the collected screen information and event information to generate a high-quality test case that is to be frequently used among users, thereby improving the test efficiency of the GUI system and a method thereof.

The objects of the present disclosure are not limited to the above-mentioned objects, and other objects and advantages of the present disclosure which are not mentioned may be understood by the following description, and will be more clearly understood by embodiments of the present disclosure. It will also be readily apparent that the objects and advantages of the disclosure may be realized by means of the instrumentalities and combinations particularly pointed out in the appended claims.

According to an aspect of the present disclosure, a graphical user interface (GUI) test case generating device may include a communication device that communicates with a GUI system mounted on a vehicle and a controller that collects screen information and event information according to a user’s manipulation through the communication device, and generates a GUI test case based on the collected screen information and event information.

According to an embodiment, the controller may generate a screen flow based on the screen information, and match the event information with the screen flow to generate the GUI test case.

According to an embodiment, the controller may generate a screen flow consisting of start screen information, at least one intermediate screen information, and arrival screen information based on the screen information, and match each screen constituting the screen flow with a corresponding key ID to generate the GUI test case.

According to an embodiment, the controller may distinguish the screen information and the event information from each other, sort the screen information in chronological order, generate a screen flow consisting of start screen information, at least one intermediate screen information, and arrival screen information based on the screen information arranged in the chronological order, and match each screen constituting the screen flow with a corresponding key ID to generate the GUI test case.

According to an embodiment, the controller may accumulate usage frequencies of the GUI test case and determine a predetermined number of test cases with upper usage frequencies as optimal test cases.

According to an embodiment, the screen information may include a scene ID, and a timestamp.

According to an embodiment, the event information may include a key ID and a timestamp.

According to an aspect of the present disclosure, a GUI test case generating method may include collecting, by a controller, screen information and event information according to a user’s manipulation from a graphical user interface (GUI) system mounted on each vehicle, and generating, by the controller, a GUI test case based on the collected screen information and event information.

According to an embodiment, the generating of the GUI test case may include generating a screen flow based on the screen information, and matching the event information with the screen flow to generate the GUI test case.

According to an embodiment, the generating of the GUI test case may include generating a screen flow including start screen information, at least one intermediate screen information, and arrival screen information based on the screen information, and generating the GUI test case by matching each screen constituting the screen flow with a corresponding key ID.

According to an embodiment, the generating of the GUI test case may include distinguishing the collected screen information and the collected event information from each other, sorting the screen information in chronological order, and generating a screen flow including start screen information, at least one intermediate screen information, and arrival screen information based on the screen information sorted in the chronological order, and generating the GUI test case by matching each screen constituting the screen flow with a corresponding key ID.

According to an embodiment, the GUI test case generating method may further include accumulating usage frequencies of the GUI test case and determining a predetermined number of test cases with upper usage frequencies as optimal test case.

According to an embodiment, the GUI test case generating method may further include storing, by a storage, the optimal test cases.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary diagram of a GUI test automation system to which an embodiment of the present disclosure is applied.

FIG. 2 is a block diagram of a GUI test case generating device according to an embodiment of the present disclosure.

FIG. 3 is a flowchart of a method for generating a GUI test case according to an embodiment of the present disclosure.

FIG. 4 is a diagram illustrating a computing system for performing a GUI test case generating method according to an embodiment of the present disclosure.

### DETAILED DESCRIPTION

Hereinafter, some embodiments of the present disclosure will be described in detail with reference to the exemplary drawings. In adding the predetermined numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

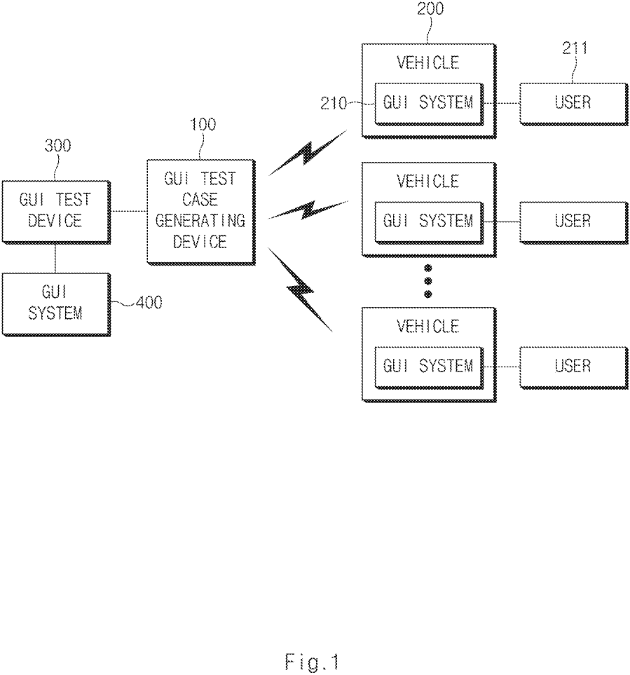

FIG. 1 is an exemplary diagram of a GUI test automation system to which an embodiment of the present disclosure is applied.

Referring to FIG. 1, a GUI test automation system to which an embodiment of the present disclosure is applied may include a GUI test case generating device 100, a vehicle 200, a GUI test device 300, and a GUI system 400.

First, according to an embodiment of the present disclosure, the GUI test case generating device 100 may collect screen information and event information according to the manipulation of a user 211 from a graphical user interface (GUI) system 210 mounted on each vehicle 200 and generate a test case based on the collected screen information and event information to generate a high-quality test case that is to be frequently used among users, thereby improving the test efficiency of the GUI system. In this case, the screen information may include a scene ID and a timestamp, and the event information may include a key ID and a timestamp.

In particular, when generating a test case based on the collected screen information and event information, the GUI test case generating device 100 may distinguish the screen information and the event information from each other, sort the screen information in chronological order, generate a screen flow including start screen information, at least one intermediate screen information, and arrival screen information based on the screen information arranged in the chronological order, and match each screen constituting the screen flow with a corresponding key ID to create an GUI test case. In this case, the GUI test case generating device 100 may perform the matching process based on the timestamp. In addition, the screen flow may refer to an order of screens to be displayed while the user manipulates a GUI to perform one function.

In addition, the GUI test case generating device 100 may accumulate usage frequencies for each test case and sort the test cases in the order of the highest usage frequency. In this case, the GUI test case generating device 100 may determine a predetermined number of test cases in the order of the highest usage frequency as optimal test cases. The determined optimal test case may be transmitted to the GUI test device 300 and used to test the GUI system 400.

Each of the plurality of vehicles 200 may include the GUI system 210, and the GUI system 210 may extract screen information and event information according to the manipulation of the user 211 and transmit the screen information and event information to the GUI test case generating device 100. In this case, the vehicle 200 may further include a telematics terminal, and the GUI system 210 may transmit the screen information and the event information to the GUI test case generating device 100 through the telematics terminal.

The GUI test device 300 may test the GUI system 400 based on the optimal test case generated by the GUI test case generating device 100. In this case, the GUI test device 300 may generate an automation script based on the optimal test case to automate a test for the GUI system 400.

Here, the script may include a list of programs or instructions that may be translated or executed by a program other than a computer processor. In general, the script may be suitable for creating programs with very limited capabilities or programs reusable in connection with a compiled program because the script may be easier to understand than languages such as C or C++ that requires compilation, and be written at a high speed.

In addition, the script may include dynamic data including movement information between screens and static data including information on each screen. For example, the dynamic data may include information on which key (or button) needs to be input to move from a current screen to an upper screen or a lower screen. The static data may include image information, area information, character string information, sound information, and the like for each screen.

The GUI test device 300 may generate an automation script function for each screen flow for a smart monkey test. In this case, the GUI test device 300 may generate the automation script function based on event statistics information for each test case.

The GUI test device 300 may generate an automation script for each path for a smoke test. In this case, the GUI test device 300 may generate the automation script for each path, which is a set of screen flows, by using the automation script function for each screen flow.

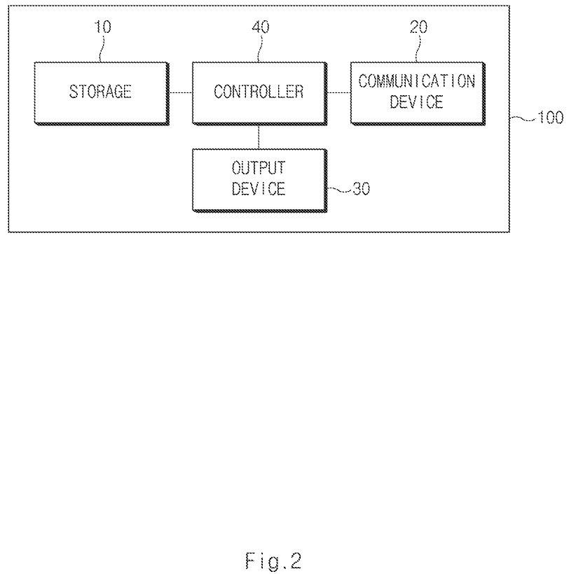

FIG. 2 is a configuration diagram of a GUI test case generating device according to an embodiment of the present disclosure.

Referring to FIG. 2, the GUI test case generating device 100 according to an embodiment of the present disclosure may include a storage 10, a communication device 20, an output device 30, and a controller 40. In this case, according to a method for performing the GUI test case generating device 100 according to an embodiment of the present disclosure, components may be combined with each other as one entity, or some components may be omitted.

The components will be described below. First, the storage 10 may store various logics, algorithms, and programs required in the process of collecting screen information and event information according to the manipulation of the user 211 from the graphical user interface (GUI) system 210 mounted on each vehicle 200 and generating a test case based on the collected screen information and event information.

In particular, the storage 10 may store various logics, algorithms, and programs required in the process of distinguishing the screen information and the event information from each other, sorting the screen information in chronological order, generating a screen flow including start screen information, at least one intermediate screen information, and arrival screen information based on the screen information arranged in the chronological order, and matching each screen constituting the screen flow with a corresponding key ID to create an GUI test case.

The storage 10 may store a plurality of test cases generated by the controller 40, and may store an accumulated usage frequency for each of the plurality of test cases. In this case, the storage 10 may separately store an optimal test case determined by the controller 40.

The storage 10 may include at least one type of storage medium of memories such as a flash memory type memory, a hard disk type memory, a micro type memory, and a card type memory (e.g., an SD card (Secure Digital Card) or an XD card (eXtream Digital Card)), a RAM (Random Access Memory), an SRAM (Static RAM), a ROM (Read Only Memory), a PROM (Programmable ROM), a EEPROM (Electrically Erasable PROM), a MRAM (Magnetic RAM), and an optical disk type memory.

The communication device 20 may be a module that provides a communication interface with the vehicle 200, and may receive screen information and event information according to a user’s manipulation from a plurality of vehicles 200. In this case, the screen information may include a scene ID and a timestamp, and the event information may include a key ID and a timestamp.

The communication device 20 may include at least one or more of a mobile communication module, a wireless Internet module, and a short-range communication module.

The mobile communication module may communicate with the vehicle 200 through a mobile communication network which is established according to a technical standard or a communication scheme for mobile communication (e.g., Global System for Mobile communication (GSM), Code Division Multi Access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), or LTE-A (Long Term Evolution-Advanced) and the like.

The wireless Internet module may be a module for access to wireless Internet and may communicate with the vehicle 200 through Wireless LAN (WLAN), Wireless-Fidelity (Wi-Fi), Wi-Fi Direct, Digital Living Network Alliance (DLNA), Wireless Broadband (WiBro), WiMAX (World Interoperability for Microwave Access (HSDPA), High Speed Downlink Packet Access (HSDPA), High Speed Uplink Packet Access (HSUPA), Long Term Evolution (LTE), Long Term Evolution-Advanced (LTE-A), or the like.

The short-range communication module may support short-range communication with the vehicle 200 using at least one of Bluetooth™, Radio Frequency Identification (RFID), Infrared Data Association (IrDA), Ultra Wideband (UWB), ZigBee, Near Field Communication (NFC), and Wireless USB (Wireless Universal Serial Bus) technologies.

The output device 30 may display a plurality of test cases generated by the controller 40 or display optimal test cases determined by the controller 40.

The controller 40 may perform overall control such that each of the above components normally performs its function. The controller 40 may be implemented in the form of hardware or software, or may be implemented in a combination of hardware and software. Preferably, the controller 40 may be implemented with a microprocessor, but is not limited thereto

In particular, the controller 40 may perform various controls required in the process of collecting screen information and event information according to the manipulation of the user 211 from the graphical user interface (GUI) system 210 mounted on each vehicle 200 and generating a test case based on the collected screen information and event information.

Hereinafter, the operation of the controller 40 will be described in detail.

The controller 40 may collect screen information and event information according to a user’s operation from a GUI system mounted on each vehicle as big data. In this case, the controller 40 may extract specific screen information and specific event information from the big data using a query, and express the extracted screen information and event information in the form of a data table. In this process, the controller 40 may convert time character string information into time series data to generate a screen flow, and may also remove singular data (missing values, outliers, incorrect values, or the like).

The controller 40 may distinguish the screen information from the event information which are collected, and sort the screen information in chronological order. In this case, the controller 40 may sort screen information in chronological order based on timestamps included in the screen information.

The controller 40 may generate a screen flow including start screen information, at least one intermediate screen information, and arrival screen information based on the screen information sorted in the chronological order. In this case, one screen flow may mean data in which screens provided to a user are sorted in chronological order in the process of performing one function.

The controller 40 may generate a GUI test case by matching each screen constituting the screen flow with a corresponding key ID. In this case, the controller 40 may match each event with each screen based on the timestamps included in the event information.

The controller 40 may accumulate usage frequencies for each test case and sort the test cases in the order of the higher usage frequencies. In this case, the controller 40 may count the same test cases from among the test cases generated from the collected big data and accumulate the usage frequencies for each case.

The controller 40 may sort test cases based on the usage frequency, and determine a predetermined number of upper test cases (with higher usage frequencies) as the optimal test cases. In this case, the predetermined number may be arbitrarily changed according to the intention of a designer. For example, when the test cases are A1, A2, A3, A4, A5. Assume that A1 is used 10 times, A2 is used 5 times, A3 is used 11 times, A4 is used 8 times, and A5 is used 15 times. When the determined number is three, the three most frequently used cases, namely A1, A3, and A5, are determined as the final test case.

The controller 40 may transmit the determined optimal test cases to the GUI test device 300 to allow the GUI test device 300 to test the GUI system 400.

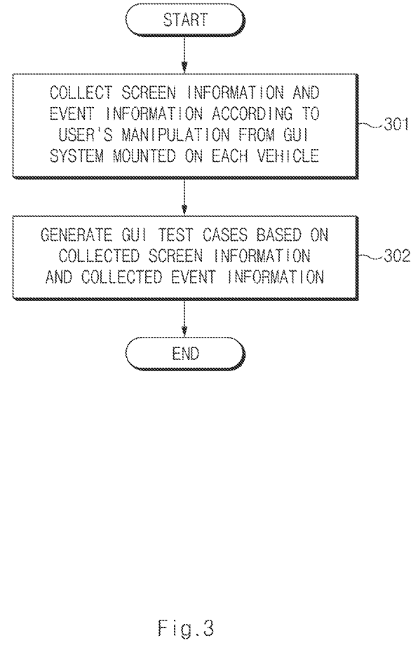

FIG. 3 is a flowchart of a method for generating a GUI test case according to an embodiment of the present disclosure.

First, the controller 40 may collect screen information and event information according to the manipulation of the user 211 from the graphical user interface (GUI) system 210 mounted on each vehicle (301).

Thereafter, the controller 40 may generate a GUI test case based on the collected screen information and event information (302) . In this case, the controller 40 may distinguish the screen information and the event information from each other, sort the screen information in chronological order, generate a screen flow including start screen information, at least one intermediate screen information, and arrival screen information based on the screen information arranged in the chronological order, and match each screen constituting the screen flow with a corresponding key ID to create an GUI test case.

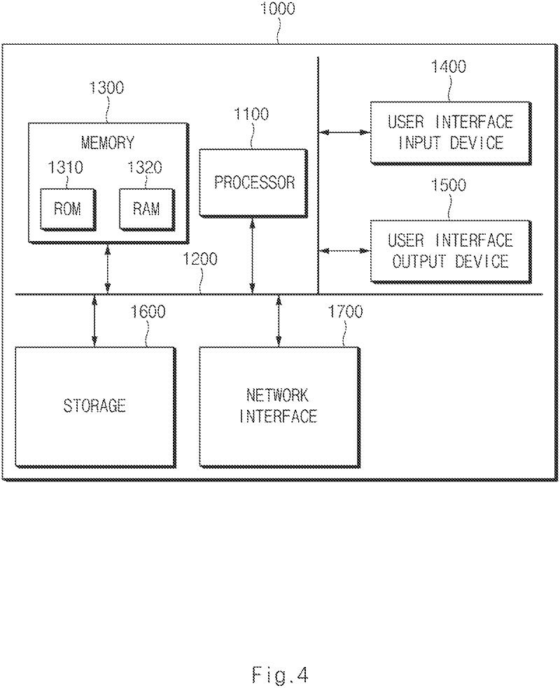

FIG. 4 is a diagram illustrating a computing system for performing a GUI test case generating method according to an embodiment of the present disclosure.

Referring to FIG. 4, the GUI test case generating method according to the embodiment of the present disclosure described above may be implemented through a computing system. A computing system 1000 may include at least one processor 1100, a memory 1300, a user interface input device 1400, a user interface output device 1500, storage 1600, and a network interface 1700, which are connected with each other via a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a solid state drive (SSD) a removable disk, and a CD-ROM. The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Therefore, the exemplary embodiments of the present disclosure are provided to explain the spirit and scope of the present disclosure, but not to limit them, so that the spirit and scope of the present disclosure is not limited by the embodiments. The scope of protection of the present disclosure should be interpreted by the following claims, and all technical ideas within the scope equivalent thereto should be construed as being included in the scope of the present disclosure.

According to the GUI test case generating device and method, it is possible to collect screen information and event information according to the manipulation of a user from a graphical user interface (GUI) system mounted on each vehicle and generate a test case based on the collected screen information and event information to generate a high-quality test case that is to be frequently used among users, thereby improving the test efficiency of the GUI system.

In addition, the GUI test case generating device and method according to an embodiment of the present disclosure as described above may generate high-quality test cases with high frequency of use among users, allow developers to distinguish between functions that are actually used frequently and functions that are not used frequently to induce deletion of functions that are not used frequently.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A graphical user interface (GUI) test case generating device comprising:
a communication device configured to communicate with a GUI system mounted on a vehicle; and
a controller configured to collect screen information and event information according to a user’s manipulation through the communication device, and generate a GUI test case based on the collected screen information and event information.

2. The GUI test case generating device of claim 1, wherein the controller is configured to generate a screen flow based on the screen information, and match the event information with the screen flow to generate the GUI test case.

3. The GUI test case generating device of claim 2, wherein the controller is configured to accumulate usage frequencies of the GUI test case and determine a predetermined number of test cases with upper usage frequencies as optimal test cases.

4. The GUI test case generating device of claim 1, wherein the controller is configured to generate a screen flow including start screen information, at least one intermediate screen information, and arrival screen information based on the screen information, and match each of screens constituting the screen flow with a corresponding key ID to generate the GUI test case.

5. The GUI test case generating device of claim 4, wherein the controller is configured to accumulate usage frequencies of the GUI test case and determine a predetermined number of test cases with upper usage frequencies as optimal test cases.

6. The GUI test case generating device of claim 1, wherein the controller is configured to distinguish the screen information and the event information from each other, sort the screen information in chronological order, generate a screen flow including start screen information, at least one intermediate screen information, and arrival screen information based on the screen information arranged in the chronological order, and match each screen constituting the screen flow with a corresponding key ID to generate the GUI test case.

7. The GUI test case generating device of claim 6, wherein the controller is configured to accumulate usage frequencies of the GUI test case and determine a predetermined number of test cases with upper usage frequencies as optimal test cases.

8. The GUI test case generating device of claim 7, further comprising:
a storage configured to store the optimal test cases.

9. The GUI test case generating device of claim 1, wherein the screen information includes a scene ID, and a timestamp.

10. The GUI test case generating device of claim 1, wherein the event information includes a key ID and a timestamp.

11. A graphical user interface (GUI) test case generating method comprising:
collecting, by a controller, screen information and event information according to a user’s manipulation from a GUI system mounted on each vehicle; and
generating, by the controller, a GUI test case based on the collected screen information and event information.

12. The GUI test case generating method of claim 11, wherein the generating of the GUI test case includes generating a screen flow based on the screen information, and matching the event information with the screen flow to generate the GUI test case.

13. The GUI test case generating method of claim 12, wherein the generating of the GUI test case includes
accumulating usage frequencies of the GUI test case; and
determining a predetermined number of test cases with upper usage frequencies as optimal test cases.

14. The GUI test case generating method of claim 11, wherein the generating of the GUI test case includes
generating a screen flow including start screen information, at least one intermediate screen information, and arrival screen information based on the screen information; and
generating a GUI test case by matching each screen constituting the screen flow with a corresponding key ID.

15. The GUI test case generating method of claim 14, wherein the generating of the GUI test case includes
accumulating usage frequencies of the GUI test case; and
determining a predetermined number of test cases with upper usage frequencies as optimal test cases.

16. The GUI test case generating method of claim 11, wherein the generating of the GUI test case includes
distinguishing the collected screen information and the collected event information from each other;
sorting the screen information in chronological order; and
generating a screen flow including start screen information, at least one intermediate screen information, and arrival screen information based on the screen information sorted in the chronological order; and
generating the GUI test case by matching each screen constituting the screen flow with a corresponding key ID.

17. The GUI test case generating method of claim 16, wherein the generating of the GUI test case includes
accumulating usage frequencies of the GUI test case; and
determining a predetermined number of test cases with upper usage frequencies as optimal test cases.

18. The GUI test case generating method of claim 17, further comprising:
storing, by a storage, the optimal test cases.

19. The GUI test case generating method of claim 11, wherein the screen information includes a scene ID, and a timestamp.

20. The GUI test case generating method of claim 11, wherein the event information includes a key ID and a timestamp.
